(19) United States
(12) Patent Application Publication
(10) Pub. No.: US 2024/0319757 A1
(43) Pub. Date: Sep. 26, 2024

(54) VOLTAGE REGULATOR

(71) Applicant: ABLIC Inc., Nagano (JP)

(72) Inventor: Kosuke TAKADA, Nagano (JP)

(73) Assignee: ABLIC Inc., Nagano (JP)

(21) Appl. No.: 18/607,590

(22) Filed: Mar. 18, 2024

(30) Foreign Application Priority Data
Mar. 23, 2023 (JP) 2023-047165
Dec. 19, 2023 (JP) 2023-213500

(51) Int. Cl. G05F 1/575

(52) U.S. Cl. CPC G05F 1/575

(57) ABSTRACT

The voltage regulator includes: an error amplification circuit, outputting a signal amplifying a difference between a reference voltage and a feedback voltage; a source ground amplification circuit, amplifying the signal supplied from the error amplification circuit and outputting the signal as a control signal; and an output transistor, including a gate to which the control signal is supplied and outputting an output voltage. The source ground amplification circuit includes: a phase advance compensation circuit, containing a resistor and a capacitor; a load, containing a resistor and an offset generation element generating an offset voltage; and a transistor, containing: a gate receiving the signal output from the error amplification circuit; a source being connected with a first end of the resistor and a first end of the capacitor, the resistor and the capacitor being contained in the phase advance compensation circuit; and a drain connected with the load.

### CROSS-REFERENCE TO RELATED APPLICATION

This application claims the priority benefits of Japanese application no. 2023-047165, filed on Mar. 23, 2023 and Japanese application no. 2023-213500, filed on Dec. 19, 2023. The entirety of each of the above-mentioned patent applications is hereby incorporated by reference herein and made a part of this specification.

### BACKGROUND

### Technical Field

The present invention relates to a voltage regulator.

### Description of Related Art

In general, a voltage regulator may receive a power voltage and generate a constant output voltage, and maintain the output voltage at a constant value even if the power voltage or a load current varies. For example, a voltage regulator includes a reference voltage source, an error amplification circuit, an output transistor, and a phase compensation circuit using a Miller capacitor.

However, in the conventional voltage regulator, since delay compensation according to the Miller capacitor is used for phase compensation of a control loop, a delay occurs in the response of the output voltage to a sudden change of a load current.

### SUMMARY

The present invention provides a voltage regulator in which an output voltage responds to a sudden change of a load current more quickly than the conventional art.

According to at least one aspect of the present invention, a voltage regulator includes: an error amplification circuit, outputting a signal amplifying a difference between a reference voltage and a feedback voltage; a source ground amplification circuit, amplifying the signal supplied from the error amplification circuit and outputting the signal as a control signal; and an output transistor, including a gate to which the control signal is supplied and outputting an output voltage. The source ground amplification circuit includes: a phase advance compensation circuit, containing a resistor and a capacitor; a load, containing an offset generation element and a resistor, the offset generation element generating an offset voltage; and a first transistor, containing a gate receiving the signal output from the error amplification circuit, a source connected with a first end of the resistor and a first end of the capacitor, the resistor and the capacitor being contained in the phase advance compensation circuit, and a drain connected with the load.

According to the present invention, a voltage regulator in which an output voltage responds to a sudden change of a load current more quickly than the conventional art can be provided.

### BRIEF DESCRIPTION OF THE DRAWINGS

FIG. 1 is a circuit diagram illustrating a configuration example of a voltage regulator according to a first embodiment.

FIG. 2 is a circuit diagram illustrating a configuration example of a voltage regulator according to a second embodiment.

### DESCRIPTION OF THE EMBODIMENTS

In the following, a voltage regulator according to the embodiments of the present invention is described based on the drawings.

### First Embodiment

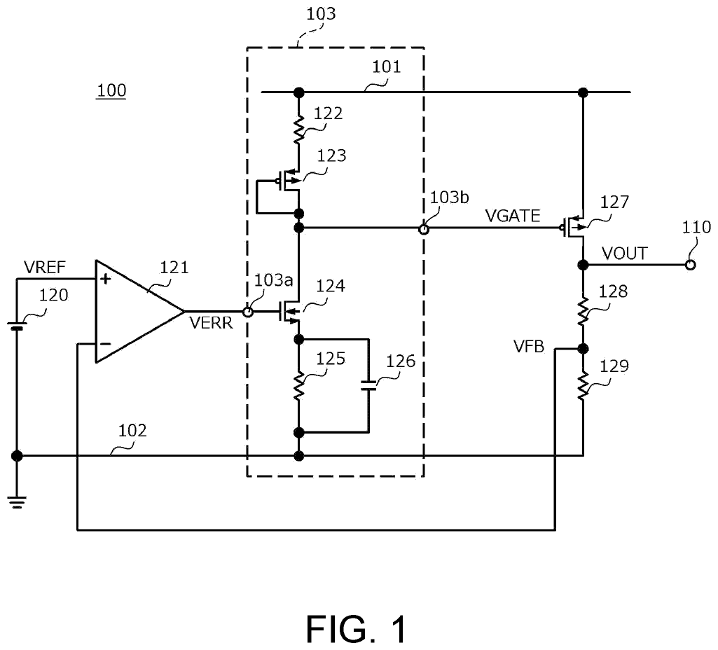

FIG. 1 is a circuit diagram of a voltage regulator 100 which is an example of a voltage regulator according to a first embodiment of the present invention.

The voltage regulator 100 includes a power terminal 101, a ground terminal 102, a reference voltage source 120, an error amplification circuit 121, a resistor 122, a PMOS transistor 123, an NMOS transistor 124, a resistor 125, a capacitor 126, a PMOS transistor 127, a resistor 128, a resistor 129, and an output terminal 110. The ground terminal 102 is a power terminal that supplies a power voltage (referred to as “ground voltage” in the following) of OV (zero volt) as an example of a power voltage serving as a reference of a circuit operation. The resistor 122, the PMOS transistor 123, the NMOS transistor 124, the resistor 125, and the capacitor 126 form a source ground amplification circuit 103.

The source ground amplification circuit 103 includes a load, a phase advance compensation circuit, and the NMOS transistor 124. The load contains the resistor 122 and the PMOS transistor 123. The phase advance compensation circuit includes the resistor 125 and the capacitor 126. In addition, the source ground amplification circuit 103 includes an input port 103a and an output port 103b. Here, the input port 103a is a connection point of an output terminal of the error amplification circuit 121 and the gate of the NMOS transistor 124, and is a node that receives a signal supplied from the error amplification circuit 121. The output port 103b is a connection point among the drain of the NMOS transistor 124, the gate and the drain of the PMOS transistor 123, and the gate of the PMOS transistor 127, and is a node that outputs a control voltage to the gate of the PMOS transistor 127.

In the reference power source 120, a port is connected with a non-inverting input terminal (+) of the error amplification circuit 121 and the other port is connected with the ground terminal 102.

In the NMOS transistor 124, the gate is connected with the output terminal of the error amplification circuit 121, the source is connected with a first end of the resistor 125 and a first end of the capacitor 126, and the drain is connected with the gate and the drain of the PMOS transistor 123 and the gate of the PMOS transistor 127.

In the resistor 122, a first end is connected with the power terminal 101, and a second end is connected with the source of the PMOS transistor 123.

In the resistor 125, a second end is connected with the ground terminal 102. In the resistor 126, a second end is connected with the ground terminal 102.

In the PMOS transistor 127 as the output transistor, the source is connected with the power terminal 101, and the drain is connected with the output terminal 110 and a first end of the resistor 128. In the resistor 128, a second end is connected with a first end of the resistor 129 and an inverting input terminal (−) of the error amplification circuit 121. In the resistor 129, a second end is connected with the ground terminal 102.

Then, an operation of the voltage regulator 100 is described.

The power terminal 101 supplies a predetermined power voltage. The ground terminal 102 supplies the ground voltage.

The output terminal 110 is an output terminal of the voltage regulator 100, and sets the voltage of the output terminal 110 as an output voltage VOUT. The resistor 128 and the resistor 129 divide the output voltage VOUT to generate a feedback voltage VFB. The error amplification circuit 121 compares the amplitudes of the feedback voltage VFB and the reference voltage VREF output from the reference voltage source to output an error voltage VERR from the output terminal. The error voltage VERR is supplied to the source ground amplification circuit 103 (more specifically, the gate of the NMOS transistor 124).

In the source ground amplification circuit 103, an advance compensation is generated by using the NMOS transistor 124, the resistor 125, and the capacitor 126. In addition, an offset voltage is generated between two ends, i.e., the source and the drain, of the PMOS transistor 123 serving as an offset generation element. That is, the offset generation element is configured by the PMOS transistor 123. In the source ground amplification circuit 103, since the offset voltage is generated between the source and the drain of the PMOS transistor 123, the impedance of the load is reduced, and the gain is reduced. A signal amplified by the source ground amplification circuit 103 is supplied, as a control circuit, from the output port 103b to the gate of the PMOS transistor 127. The PMOS transistor 127 receives, at the gate, a voltage VGATE as the control signal, and outputs, at the drain, an output voltage VOUT. The output voltage VOUT is supplied to the output terminal 110 connected with the drain of the PMOS transistor 127.

Then, the reason why the impedance of the load of the source ground amplification circuit 103, the load containing the resistor 122 and the PMOS transistor 123, is reduced will be explained.

Since the gate and the drain of the PMOS transistor 123 are connected, the impedance between the source and the gain is reduced, and the PMOS transistor 123 operates as an offset generation element that generates an offset voltage between the source and the gain. A control signal for conducting the PMOS transistor 127, that is, a voltage of the PMOS transistor 127 between the gate and the source, is generated by using the offset voltage and a voltage across the resistor 122. In this way, since the offset voltage is present in the load, the voltage of the resistor 122 (voltage across the resistor 122) is lower than the case where the offset voltage is not present. As a result, the impedance of the load of the source ground amplification circuit 103 is reduced.

According to the voltage regulator 100, by adding an advance compensation of the control loop to the source ground amplification circuit 103 and further reducing the gain, the phase margin of the voltage regulator 100 can be secured. In addition, according to the voltage regulator 100, since a delay compensation according to a Miller capacitor is not used in the control loop, the output voltage can more quickly respond to a sudden change of the load current than a voltage regulator using the delay compensation according to the Miller capacitor. That is, the delay time of the response of the output voltage to a sudden change of the load current can be shorter than the conventional art.

### Second Embodiment

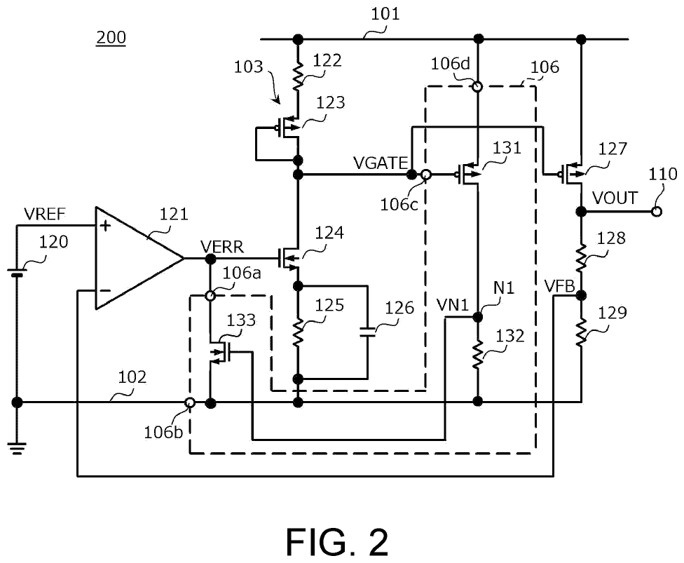

FIG. 2 is a circuit diagram of a voltage regulator 200 which is an example of a voltage regulator according to a second embodiment of the present invention.

Compared with the voltage regulator 100, the voltage regulator 200 differs in further including an overcurrent protection circuit 106, and the rest of the voltage regulator 200 is substantially the same as the voltage regulator 100. Thus, the description of the embodiment focuses on the overcurrent protection circuit 106. For components repeating those of the voltage regulator 100, the same reference symbols are used, and the description thereof is omitted.

The voltage regulator 200 includes the power terminal 101, the ground terminal 102, the reference voltage source 120, the error amplification circuit 121, the resistor 122, the PMOS transistor 123, the NMOS transistor 124, the resistor 125, the capacitor 126, the PMOS transistor 127, the resistor 128, the resistor 129, an overcurrent protection circuit 106, and the output terminal 110.

The overcurrent protection circuit 106 includes a PMOS transistor 131, a resistor 132, and an NMOS transistor 133. The PMOS transistor 131 and the resistor 132 form a voltage generation circuit that generates a voltage VN1 at a node N1 that serves as a connection point between the PMOS transistor 131 and the resistor 132.

The overcurrent protection circuit 106 has connection ports 106a to 106d for external connection of the overcurrent protection circuit 106. The connection port 106a is connected with the output terminal of the error amplification circuit 121 and the gate of the NMOS transistor 124. The connection port 106b is connected with the ground terminal 102. The connection port 106c is connected with the gate and the drain of the PMOS transistor 123, the gate of the NMOS transistor 124, and the gate of the PMOS transistor 127, and receives the voltage VGATE. The connection port 106d is connected with the power terminal 101.

In the PMOS transistor 131, the source is connected with the power terminal 101, the gate is connected with the connection point among the drain of the NMOS transistor 124, the gate and the drain of the PMOS transistor 123, and the gate of the PMOS transistor 127, and the drain is connected with a port of the resistor 132. In the resistor 132, the other port is connected with the ground terminal 102. In the NMOS transistor 133, the drain is connected with the connection point of the output terminal of the error amplification circuit 121 and the gate of the NMOS transistor 124, the source is connected with the ground terminal 102, and the gate is connected with the node N1. That is, as a switch, the NMOS transistor 133 switches a path connecting the output terminal of the error amplification circuit 121 and the ground terminal 102 between a conductive (ON) state and an open (OFF) state in accordance with the voltage VN1 as an example of a voltage based on the control signal.

Then, an operation of the voltage regulator 200 is described. In the description of the operation of the voltage regulator 200, the description mainly focuses on the case where the output terminal 110 is shorted to the ground terminal 102, and the overcurrent protection circuit 106 is operating.

The same voltage VGATE is applied to the gate of the PMOS transistor 131 and the gate of the PMOS transistor 127 that are the same node. Proportional drain currents flow through the PMOS transistor 131 and the PMOS transistor 127. The drain current of the PMOS transistor 127 flows to the resistor 132 and generates the voltage VN1 at the node N1.

Assuming that the drain currents of the PMOS transistors 127, 131 increase, and the voltage VN1 exceeds a threshold voltage of the NMOS transistor 133, the NMOS transistor 133 is turned ON, and the gate voltage of the NMOS transistor 124 decreases. In the case where the gate voltage of the NMOS transistor 124 decreases, the voltage VGATE increases. Thus, the drain current of the PMOS transistor 127 and the drain current of the PMOS transistor 131 decrease. In this way, in the voltage regulator 200, a negative feedback loop is formed, and the overcurrent protection circuit 106 performs an overcurrent protection operation in accordance with the negative feedback of the negative feedback loop formed in the voltage regulator 200.

Like the voltage regulator 100, according to the voltage regulator 200, the output voltage can more quickly respond to a sudden change of a load current than the conventional art. In addition, in the voltage regulator 200, the negative feedback loop that turns ON the PMOS transistor 133 to decrease the drain currents of the PMOS transistors 127, 131 in the case where the drain currents of the PMOS transistors 127, 131 increase and the voltage VN1 exceeds the threshold voltage of the NMOS transistor 133 is formed. Thus, it is possible to carry out overcurrent protection. According to the voltage regulator 200, the source ground circuit 103 is included in the negative feedback loop that is formed. Thus, the overcurrent protection function can quickly respond to a sudden change of the load current. That is, the overcurrent protection function can more quickly respond to a sudden change of the load current than the conventional art.

Although the embodiment of the present invention has been described above, the present invention is not limited to the above embodiment, and various changes may be made within the range without departing from the spirit of the present invention. These embodiments and their modifications are included within the scope and gist of the present invention, as well as within the scope of the present invention described in the claims and its equivalents.

What is claimed is:

1. A voltage regulator, comprising:
an error amplification circuit, outputting a signal amplifying a difference between a reference voltage and a feedback voltage;
a source ground amplification circuit, amplifying the signal supplied from the error amplification circuit and outputting the signal as a control signal; and
an output transistor, including a gate to which the control signal is supplied and outputting an output voltage,
the source ground amplification circuit, including a phase advance compensation circuit containing a resistor and a capacitor, a load containing a resistor and an offset generation element generating an offset voltage, and a first transistor containing a gate receiving the signal output from the error amplification circuit, a source connected with a first end of the resistor and a first end of the capacitor, the resistor and the capacitor being contained in the phase advance compensation circuit, and a drain connected with the load.

2. The voltage regulator according to claim 1, comprising an overcurrent protection circuit including a switch switching a path between a conductive state and an open state in accordance with a voltage based on the control signal, the path connecting an output terminal of the error amplification circuit and a power terminal supplying a power voltage as a reference of a circuit operation.

3. The voltage regulator according to claim 1, comprising an overcurrent protection circuit including: a voltage generation circuit connected between a first power terminal supplying a first power voltage and a second power terminal supplying a second power voltage, and generating a voltage based on the control signal; and a switch, switching a path between a conductive state and an open state in accordance with a voltage generated by the voltage generation circuit, the path connecting an output voltage of the error amplification circuit and the first power terminal.

4. The voltage regulator according to claim 1, wherein the offset generation element is configured by a second transistor containing a gate and a drain connected to the gate of the second transistor.

5. The voltage regulator according to claim 2, wherein the offset generation element is configured by a second transistor containing a gate and a drain connected to the gate of the second transistor.

6. The voltage regulator according to claim 3, wherein the offset generation element is configured by a second transistor containing a gate and a drain connected to the gate of the second transistor.
